(19) United States
(12) Patent Application Publication
(10) Pub. No.: US 2025/0075083 A1
(43) Pub. Date: Mar. 6, 2025

(54) PRIMER COATING COMPOSITION, PRIMER LAYER, AND GASKET

(71) Applicant: ISHIKAWA GASKET CO., LTD., Tokyo (JP)

(72) Inventor: Yuuichi Kinoshita, Tokyo (JP)

(21) Appl. No.: 18/823,242

(22) Filed: Sep. 3, 2024

(30) Foreign Application Priority Data
Sep. 6, 2023 (JP) 2023-144521

(51) Int. Cl. C09D 5/00; C08L 27/18; C09D 7/20; C09D 7/40; C09D 7/65; C09D 163/00; F16J 15/08

(52) U.S. Cl. CPC C09D 5/002; C08L 27/18; C09D 7/20; C09D 7/65; C09D 7/69; C09D 163/00; F16J 15/0806

(57) ABSTRACT

The present invention provides a primer coating composition including: an epoxy resin; and fine fluororesin particles. The present invention also provides a primer layer obtained by curing the primer coating composition. The present invention also provides a gasket having the primer layer directly formed on at least a portion thereof.

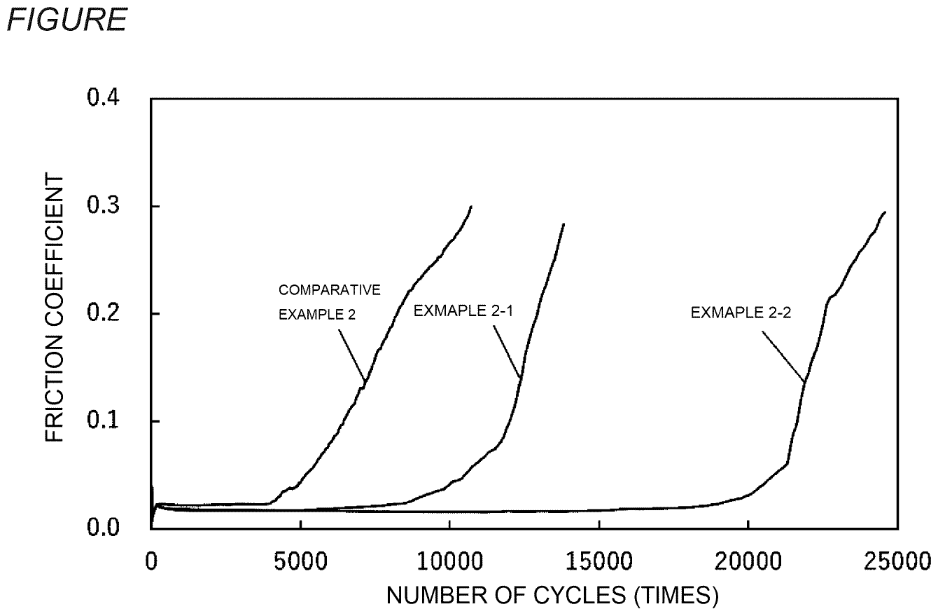

### CROSS-REFERENCE TO RELATED APPLICATIONS

This application is based on and claims priority under 35 USC 119 from Japanese Patent Application No. 2023-144521 filed on Sep. 6, 2023, the entire content of which is incorporated herein by reference.

### TECHNICAL FIELD

The present invention relates to a primer coating composition, a primer layer obtained by curing the primer coating composition, and a gasket having the primer layer directly formed on at least a portion thereof.

### BACKGROUND ART

In the related art, layers are laminated onto a substrate such as a metal or a polymer to impart desired properties to the substrate. From the viewpoint of workability, a coating material is widely used to form the layers, and the properties exhibited by the layers vary depending on components to be blended into the coating material.

Patent Literature 1 discloses that when an iron alloy body is coated with a coating material made of an epoxy resin containing fine inorganic particles, even when the iron alloy body is heated to a high temperature to cure a coating film, a layer having a uniform width and thickness is obtained. In addition, Patent Literature 2 discloses that when a gasket is coated with a coating material containing a specific urethane resin, solid lubricant, and solvent in a specified ratio to cover an elastomer, it is possible to prevent elastomer components from adhering to a mating material without impairing sealing properties inherent to the gasket.

### CITATION LIST

### Patent Literature

Patent Literature 1: JPH10-036764A
Patent Literature 2: JP2012-219183A

### SUMMARY OF INVENTION

### Technical Problem

On the other hand, in a member whose performance is greatly influenced by damage to the substrate, such as a gasket, it is important to provide a primer layer having excellent adhesion and abrasion resistance on the substrate. However, at present, there are almost no primer coating composition precisely designed from such a viewpoint, and even present, such a primer coating composition does not provide sufficient performance.

An object of the present invention is to provide a primer coating composition which gives a primer layer having excellent adhesion to a substrate, having excellent abrasion resistance, and capable of preventing damage to the substrate. Another example of the present invention is to provide a primer layer obtained by curing the primer coating composition, and a gasket having the primer layer directly formed on at least a portion thereof.

### Solution to Problem

As a result of careful consideration, the inventors of the present invention have found that when a primer coating composition containing an epoxy resin and fine fluororesin particles is used, it is possible to obtain a primer layer having excellent adhesion to a substrate, having excellent abrasion resistance, and capable of preventing damage to the substrate. Thus, the present invention has been completed. That is, the present invention relates to the following.

<1>

A primer coating composition including: an epoxy resin; and fine fluororesin particles.

<2>

The primer coating composition according to <1>, in which the fine fluororesin particles are at least one kind selected from the group consisting of polytetrafluoroethylene (PTFE), a tetrafluoroethylene-perfluoroalkoxyethylene copolymer (PFA), a tetrafluoroethylene-hexafluoropropylene copolymer (FEP), a tetrafluoroethylene-ethylene copolymer (ETFE), polyvinylidene fluoride (PVDF), polychlorotrifluoroethylene (PCTFE), and an ethylene-chlorotrifluoroethylene copolymer (ECTFE).

<3>

The primer coating composition according to <1> or <2>, in which the fine fluororesin particles are contained in an amount of 5 to 50 parts by mass with respect to 100 parts by mass of the epoxy resin.

<4>

The primer coating composition according to any one of <1> to <3>, in which the fine fluororesin particles have an average particle diameter of 3 μm to 18 μm.

<5>

Use of the primer coating composition according to any one of <1> to <3> for coating a surface of a metal material.

<6>

Use of the primer coating composition according to any one of <1> to <3> for coating a surface of a metal material of a gasket.

<7>

A primer layer, which is obtained by curing the primer coating composition according to any one of <1> to <6>.

<8>

A gasket including: the primer layer according to <7>directly formed on at least a portion thereof.

### Advantageous Effects of Invention

According to the aspect of non-limiting embodiments of the present disclosure, it is possible to provide a primer coating composition which gives a primer layer having excellent adhesion to a substrate, having excellent abrasion resistance, and capable of preventing damage to the substrate.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

### BRIEF DESCRIPTION OF DRAWINGS

The FIGURE is a diagram showing results of a compression-torsion test on evaluation samples in Examples and Comparative Example.

### DESCRIPTION OF EMBODIMENTS

Hereinafter, a primer coating composition, a primer layer obtained by curing the primer coating composition, and a gasket having the primer layer directly formed on at least a portion thereof according to the present disclosure will be described in detail.

Note that, the present invention is not limited to the embodiment described below. In the present description, numerical ranges expressed using “to” include the numerical values before and after “to”. For example, “P to Q” means “P or more and Q or less”.

### <Primer Coating Composition>

The primer coating composition according to the present disclosure contains an epoxy resin and fine fluororesin particles. Accordingly, it is possible to provide a primer coating composition which gives a primer layer having excellent adhesion to a substrate, having excellent abrasion resistance, and capable of preventing damage to the substrate.

### [Epoxy Resin]

The primer coating composition according to the present disclosure contains an epoxy resin. The kind of the epoxy resin is not particularly limited, and an epoxy resin having two or more epoxy groups in one molecule is preferred.

Preferred examples of the epoxy resin include: a bisphenol type epoxy resin such as a bisphenol A type epoxy resin and a bisphenol F type epoxy resin; a naphthalene type epoxy resin; a biphenyl type epoxy resin; a novolac type epoxy resin such as a phenol novolac type epoxy resin and a cresol novolac type epoxy resin; an alicyclic epoxy resin; a glycidyl amine type resin; a heterocyclic epoxy resin; and a multifunctional epoxy resin. These may be used alone or in combination of two or more kinds thereof.

Further specific examples of the epoxy resin include Yuka resin RE-1050 (manufactured by Yoshimura Oil Chemical Co., Ltd.), ECOBOND SEW-47S (manufactured by SNC Chemicals), ADEKA RESIN EM-101-50 (manufactured by ADEKA CORPORATION), ADEKA RESIN EM-0425C (manufactured by ADEKA CORPORATION), jER1001 (manufactured by Mitsubishi Chemical Group Corporation), jER1004 (manufactured by Mitsubishi Chemical Group Corporation), jER1004F (manufactured by Mitsubishi Chemical Group Corporation), jER1007 (manufactured by Mitsubishi Chemical Group Corporation), jER4005P (manufactured by Mitsubishi Chemical Group Corporation), EPICLON1050 (manufactured by DIC CORPORATION), EPICLON3050 (manufactured by DIC CORPORATION), EPICLON4050 (manufactured by DIC CORPORATION), Epotohto YD014D (manufactured by NIPPON STEEL Chemical & Material Co., Ltd.), and EPONANYANPES-904 (manufactured by NAN YA PLASTICS CORPORATION).

A softening point of the epoxy resin is not particularly limited, and is preferably 120° C. to 200° C., more preferably 140° C. to 200° C., and still more preferably 150° C. to 200° C., from the viewpoint of heat resistance.

In addition, an epoxy equivalent of the epoxy resin is not particularly limited, and is preferably 20 to 60, more preferably 20 to 50, and still more preferably 30 to 50, from the viewpoint of abrasion resistance and strength.

### [Fine Fluororesin Particles]

The primer coating composition according to the present disclosure contains fine fluororesin particles. The kind of the fine fluororesin particles is not particularly limited, and preferred examples of the fine fluororesin particles include polytetrafluoroethylene (PTFE), a tetrafluoroethylene-perfluoroalkoxyethylene copolymer (PFA), a tetrafluoroethylene-hexafluoropropylene copolymer (FEP), a tetrafluoroethylene-ethylene copolymer (ETFE), polyvinylidene fluoride (PVDF), polychlorotrifluoroethylene (PCTFE), and an ethylene-chlorotrifluoroethylene copolymer (ECTFE). These may be used alone or in combination of two or more kinds thereof.

In the primer coating composition according to the present disclosure, a content of the fine fluororesin particles is not particularly limited and can be freely set depending on the properties required of the primer coating composition. As the content of the fine fluororesin particles, the fine fluororesin particles are contained in an amount of preferably 5 to 50 parts by mass, and more preferably 5 to 30 parts by mass, with respect to 100 parts by mass of the epoxy resin.

The primer coating composition preferably contains the fine fluororesin particles in an amount of 5 parts by mass or more with respect to 100 parts by mass of the epoxy resin since the abrasion resistance of the obtained primer layer can be improved to a preferred range. In addition, the primer coating composition preferably contains the fine fluororesin particles in an amount of 50 parts by mass or less with respect to 100 parts by mass of the epoxy resin since the abrasion resistance and the adhesion to the substrate of the obtained primer layer can be both achieved within a preferred range.

An average particle diameter of the fine fluororesin particles is not particularly limited and can be freely set depending on the properties required of the primer coating composition. The average particle diameter of the fine fluororesin particles is preferably 3 μm to 18 μm, more preferably 3 μm to 10 μm, and still more preferably 3 μm to 8 μm.

The primer coating composition preferably contains the fine fluororesin particles having an average particle diameter of 3 μm or more since the abrasion resistance of the obtained primer layer can be improved to a preferred range. In addition, the primer coating composition preferably contains the fine fluororesin particles having an average particle diameter of 18 μm or less since the abrasion resistance and the adhesion to the substrate of the obtained primer layer can be both achieved within a preferred range.

Note that, in the present description, the average particle diameter of the fine fluororesin particles refers to a 50% particle diameter (D₅₀) in a volume-based particle size distribution, and is determined based on a particle size distribution measured using a laser diffraction/scattering type particle size distribution measuring device. The average particle diameter of the fine fluororesin particles is expressed as a sphere equivalent diameter determined by a laser diffraction/scattering method.

When the primer coating composition contains the fine fluororesin particles, the strength of the primer layer is increased and the primer layer is less likely to disappear due to abrasion, thereby preventing the damage to the substrate.

In addition, when the primer coating composition contains the fine fluororesin particles, an influence on smoothness of a top surface of a coating film formed on the substrate is small, so that fine fluororesin particles having an average particle diameter larger than that of a composition for forming another layer can be used. Accordingly, the primer coating composition according to the present disclosure can exhibit a more excellent effect in preventing the damage to the substrate.

### [Optional Component]

The primer coating composition according to the present disclosure can contain the following optional components in a range not impairing the performance, in addition to the epoxy resin and the fine fluororesin particles.

### (Solvent)

The primer coating composition according to the present disclosure can further contain a solvent if necessary. The kind of the solvent is not particularly limited, and preferred examples of the solvent include organic solvents: for example, aromatic solvents such as toluene, xylene, and mesitylene; alcohols such as propanol, butanol, propylene glycol monomethyl ether, and dipropylene glycol monomethyl ether; ketones such as methyl ethyl ketone, methyl isobutyl ketone, methyl amyl ketone, and isophorone; and esters such as ethyl acetate and butyl acetate. As the solvent, an aqueous solvent may be used in addition to the organic solvent. The aqueous solvent may be, for example, at least one of water and any aqueous solution. The solvent may be used alone or in any combination of two or more kinds in any ratio.

When the primer coating composition according to the present disclosure contains a solvent, a content of the solvent is preferably 40 to 70 parts by mass, and more preferably 40 to 60 parts by mass, with respect to 100 parts by mass of the total primer coating composition, from the viewpoint of ensuring a film thickness.

### (Other Optional Components)

The primer coating composition according to the present disclosure can further contain other optional components if necessary. The kind of the other optional components is not particularly limited, and preferred examples of the component include: a plasticizer; a curing agent; a leveling agent; a defoamer; a pigment dispersant; a silane coupling agent; a UV absorber; an antioxidant; a thickener; a vulcanizing agent; a filler such as silica, talc, clay, mica, calcium carbonate, magnesium oxide, calcium hydroxide, wollastonite, and carbon black; a stabilizer; and an anti-blocking agent. These optional components may be used alone or in any combination of two or more kinds in any ratio.

### [Substrate and Use Thereof]

The primer coating composition according to the present disclosure can form a primer layer by coating a surface of a substrate with the primer coating composition according to the present disclosure.

The substrate with which the primer coating composition according to the present disclosure is coated is not particularly limited, and examples thereof include: metal materials selected from metals such as iron, steel, copper, aluminum, tin, and zinc, and alloys containing these metals; and plastic materials selected from a polypropylene resin, a polycarbonate resin, a urethane resin, a polyester resin, a polystyrene resin, an ABS resin, a polyvinyl chloride resin, and a polyamide resin. The substrate can be appropriately selected depending on the use.

If necessary, before being coated with the primer coating composition, the metal material may be subjected to chromate treatments using trivalent chromium or hexavalent chromium, chemical treatments such as a non-chromate treatment such as a zinc phosphate treatment and a zirconium treatment, and surface treatments such as a corona discharge treatment, a UV/ozone treatment, a plasma treatment, an oxygen plasma treatment, a flame treatment, and a solvent treatment.

If necessary, before being coated with the primer coating composition, the plastic material may be subjected to surface treatments such as a corona discharge treatment, a UV/ozone treatment, a plasma treatment, an oxygen plasma treatment, a flame treatment, and a solvent treatment.

The surface of the metal material as the substrate is preferably coated with the primer coating composition according to the present disclosure since the adhesion to the substrate is excellent, the abrasion resistance is excellent, and an effect in preventing the damage to the substrate is remarkably exhibited. That is, the primer coating composition according to the present disclosure is preferably a primer coating composition for coating the surface of the metal material.

In addition, from the viewpoint of ensuring the strength of a gasket, the metal material is more preferably a stainless steel material.

The use of the metal material coated with the primer coating composition according to the present disclosure is not particularly limited, and it is preferably a metal material for constituting a member in which the damage to the substrate has a great influence on the performance. Examples of such a metal material include a metal material for a gasket, a metal material for a packing, a metal material for a screw, and a metal material for a nut. Among them, a metal material for a gasket or a metal material for a packing in which the damage to the substrate has a great influence on airtightness, particularly the metal material for a gasket, is preferably coated with the primer coating composition according to the present disclosure since it makes it possible to exhibit the effects of the present disclosure more remarkably.

That is, the primer coating composition according to the present disclosure is more preferably a primer coating composition for coating the surface of the metal material for a gasket.

### [Method for Producing Primer Coating Composition]

The primer coating composition according to the present disclosure can be produced by any method. Examples of the production method include mixing components to be contained in the primer coating composition. For mixing the components, for example, a mixing machine, a dispersion machine, or a kneading machine, such as a roller mill, a ball mill, a bead mill, a pebble mill, a sand grind mill, a pot mill, a paint shaker, or a disperser can be used.

### <Primer Layer>

The present disclosure also relates to a primer layer obtained by curing the above primer coating composition.

Components contained in the primer layer according to the present disclosure and preferred embodiments thereof are the same as those described above for the primer coating composition. However, among the components contained in the primer coating composition, components such as a solvent that volatilizes or disappears when the primer layer is formed are not contained in the primer layer.

A thickness of the primer layer according to the present disclosure is not particularly limited, and can be appropriately changed depending on the purpose, use, and the like. From the viewpoint of sealing against water, oil, and combustion gas in an engine, and from the viewpoint of improving the abrasion resistance of the gasket, the thickness of the primer layer is preferably 5 μm to 20 μm, more preferably 10 μm to 20 μm, and still more preferably 15 μm to 20 μm.

The primer layer according to the present disclosure can be produced by any method. Examples of the production method include coating a surface of a substrate with the primer coating composition according to the present disclosure by spraying, dipping, brushing, roll coating, or other methods, curing the primer coating composition according to the present disclosure by drying and/or baking under drying and/or baking conditions appropriate for each coating method, and applying a printing treatment such a screen printing.

### <Gasket>

The present disclosure also relates to a gasket having the above primer layer directly formed on at least a portion thereof. Since the gasket according to the present disclosure can have a primer layer having excellent adhesion to a surface of a gasket, having excellent abrasion resistance, and capable of preventing damage to the surface of the gasket directly formed on at least a portion thereof, durability, reliability, and crack resistance are excellent, and a risk of attack on the engine is reduced.

Components contained in the primer layer formed in the gasket according to the present disclosure and preferred embodiments thereof are the same as those described above for the primer layer. In addition, materials constituting the gasket and preferred embodiments thereof are the same as those described above for the substrate.

### [Additional Layer]

The gasket according to the present disclosure may include an additional layer on a surface opposite to a gasket-facing surface of the primer layer. The additional layer is not particularly limited, and can be appropriately selected depending on the purpose and the environment in which the gasket is to be used. Examples of the additional layer include a rubber layer and a lubricating layer. The additional layer may be formed in a single layer or in any combination of two or more layers.

### (Rubber Layer)

The rubber layer can have the role of improving the heat resistance and providing micro-sealing properties. The rubber layer may be made of a known rubber having excellent heat resistance. Examples of the rubber having excellent heat resistance include synthetic rubbers such as a fluororubber and a silicone rubber, and a fluororubber is preferred.

When the rubber layer is included, a thickness thereof is not particularly limited, and can be appropriately changed depending on the purpose, use, and the like. The thickness of the rubber layer is preferably 3 μm to 15 μm.

### (Lubricating Layer)

The lubricating layer may be made of any known solid lubricant as long as it has excellent lubricity. Examples of the solid lubricant include fine particles of fluororesin, molybdenum disulfide, or graphite. The lubricating layer may be composed of only a solid lubricant, or may also contain a binder as a binding agent to improve the adhesion to a lower layer. The lubricating layer may be formed by combining an epoxy resin as a binding agent and fine fluororesin particles.

When the lubricating layer is included, a thickness thereof is not particularly limited, and can be appropriately changed depending on the purpose, use, and the like. The thickness of the lubricating layer is preferably 5 μm to 15 μm.

### [Use]

The gasket according to the present disclosure has excellent durability, reliability, and crack resistance, and can have a reduced risk of attack on the engine, and can thus be suitably used in internal combustion engines such as a vehicle engine, a pipe, and the like.

### EXAMPLES

### Production Example 1: Preparation of Base Coating Composition A

A bisphenol A type epoxy resin (100 parts by mass; YD-014 manufactured by NIPPON STEEL Chemical & Material Co., Ltd.), 20 parts by mass of an amine-based curing agent (JEFFAMINE D-230 manufactured by Huntsman Corporation), 10 parts by mass of carbon black (N762 manufactured by Cabot Corporation), 30 parts by mass of talc (P-3 manufactured by Nippon Talc Co., Ltd.), 20 parts by mass of calcium carbonate (ESCALON #2000 manufactured by Sankyo Seifun Co., Ltd.), and 10 parts by mass of silica (AEROSIL 200 manufactured by NIPPON AEROSIL CO., LTD.) were uniformly dissolved in isophorone to a solid content of 30%, to prepare a base coating composition A.

### Production Example 2: Preparation of Base Coating Composition B

A fluororubber (vinylidene fluoride-hexafluoropropylene-based copolymer) (100 parts by mass; Viton A-200 manufactured by the Chemours Company), 20 parts by mass of carbon black (N762 manufactured by Cabot Corporation), 6 parts by mass of calcium hydroxide (CALDIC #1000 manufactured by Ohmi Chemical Industry Co., Ltd.), 3 parts by mass of magnesium oxide (Kyowamag 150 manufactured by Kyowa Chemical Industry Co., Ltd.), 2 parts by mass of a vulcanizing agent (Curative #20 manufactured by the Chemours Company), and 4 parts by mass of a vulcanizing agent (Curative #30 manufactured by the Chemours Company) were uniformly dissolved in isophorone to a solid content of 30%, to prepare a base coating composition B.

### Production Example 3: Preparation of Lubricating Layer Forming Composition 1

A bisphenol A type epoxy resin (100 parts by mass; YD-014 manufactured by NIPPON STEEL Chemical & Material Co., Ltd.), 20 parts by mass of an amine-based curing agent (JEFFAMINE D-230 manufactured by Huntsman Corporation), 5 parts by mass of carbon black (N762 manufactured by Cabot Corporation), 15 parts by mass of talc (P-3 manufactured by Nippon Talc Co., Ltd.), 10 parts by mass of calcium carbonate (ESCALON #2000 manufactured by Sankyo Seifun Co., Ltd.), and 100 parts by mass of fine fluororesin particles (polytetrafluoroethylene (PTFE, average particle diameter: 6μ, Fluo 300 manufactured by Micro Powders, Inc.)) were uniformly dissolved in isophorone to a solid content of 30%, to prepare a lubricating layer forming composition 1.

### Production Example 4: Preparation of Rubber Layer Forming Composition 1

Fine fluororesin particles (20 parts by mass; polytetrafluoroethylene (PTFE, average particle diameter: 6μ, Fluo 300 manufactured by Micro Powders, Inc.)) were added to 100 parts by mass of the base coating composition B, followed by uniform mixing, to prepare a rubber layer forming composition 1.

### Example 1: Preparation of Primer Coating Composition 1

Fine fluororesin particles (polytetrafluoroethylene (PTFE, average particle diameter: 6μ, Fluo 300 manufactured by Micro Powders, Inc.)) were added to 100 parts by mass of the base coating composition A, followed by uniform mixing, to prepare a primer coating composition 1. The content of the fine fluororesin particles was 20 parts by mass with respect to 100 parts by mass of the bisphenol A type epoxy resin.

### Comparative Example 1: Preparation of Primer Coating Composition 2

The base coating composition A was used as a primer coating composition 2 without adding the fine fluororesin particles.

### Example 2-1: Production of Gasket 1

The primer coating composition 1 was printed on a flat substrate (stainless steel SUS301H subjected to a chromate treatment, dimensions: 100 mm×100 mm×0.2 mm) by using a screen printer, to form a primer layer having a thickness of 10.5 μm. On the obtained primer layer, the rubber layer forming composition 1 was printed by using the screen printer to form a rubber layer having a thickness of 7.5 μm. On the obtained rubber layer, the lubricating layer forming composition 1 was printed by using the screen printer to form a lubricating layer having a thickness of 10.0 μm, and a gasket 1 was obtained. The obtained gasket 1 had the primer layer, the rubber layer, and the lubricating layer laminated in this order from the substrate side, and the total thickness of the layers excluding the substrate was 28.0 μm.

### Example 2-2: Production of Gasket 2

A gasket 2 was obtained in the same manner as in Example 2-1, except that the thickness of the primer layer was 17.5 μm, the thickness of the rubber layer was 7.5 μm, and the thickness of the lubricating layer was 7.5 μm. The obtained gasket 2 had the primer layer, the rubber layer, and the lubricating layer laminated in this order from the substrate side, and the total thickness of the layers excluding the substrate was 32.5 μm.

### Comparative Example 2: Production of Gasket 3

The primer coating composition 2 was printed on a flat substrate (stainless steel SUS301H subjected to a chromate treatment, dimensions: 100 mm×100 mm×0.2 mm) by using a screen printer, to form a primer layer having a thickness of 11.5 μm. On the obtained primer layer, the rubber layer forming composition 1 was printed by using the screen printer to form a rubber layer having a thickness of 13.5 μm. On the obtained rubber layer, the lubricating layer forming composition 1 was printed by using the screen printer to form a lubricating layer having a thickness of 10.0 μm, and a gasket 3 was obtained. The obtained gasket 3 had the primer layer, the rubber layer, and the lubricating layer laminated in this order from the substrate side, and the total thickness of the layers excluding the substrate was 35.0 μm.

### <Gasket Evaluation: Compression-Torsion Test>

A ring-shaped test jig (aluminum-based alloy A2618; diameter φ: 60 mm, hollow portion diameter φ: 30 mm, thickness: 30 mm; processed by Ishikawa Gasket Co., Ltd.) was placed on the lubricating layer of the obtained gasket to prepare an evaluation sample, which was then set in a compression-torsion tester (manufactured by Shimadzu Corporation). The compression-torsion tester was set such that a load of 200 MPa was applied to the evaluation sample at a temperature of 200° C., and a test was performed in which the sample was repeatedly slid at 10 Hz within an angle range of 1 degree. After 18,000 cycles, the test jig was removed from the evaluation sample, and the surface of the evaluation sample was visually observed and evaluated as follows. Note that, in the following evaluation, when a resin layer remained on the surface of the evaluation sample, it was determined that at least the primer layer remained in a state of adhering to the substrate. The results are shown in Table 1.
A (good): the primer layer remains on 75% or more (area ratio) of the surface of the substrate.
B (no problem): the primer layer remains on 50% or more and less than 75% (area ratio) of the surface of the substrate.
C (poor): the primer layer remains on less than 50% (area ratio) of the surface of the substrate.

Figure shows a relationship between the number of cycles in the compression-torsion test and a friction coefficient.

TABLE 1

| | Example 2-1 | Example 2-2 | Comparative Example 2 |
|---|---|---|---|
| | Gasket 1 | Gasket 2 | Gasket 3 |
| Primer layer: thickness | 10.5 μm | 17.5 μm | 11.5 μm |
| Rubber layer: thickness | 7.5 μm | 7.5 μm | 13.5 μm |
| Lubricating layer: thickness | 10.0 μm | 7.5 μm | 10.0 μm |
| Primer layer + rubber layer + | 28.0 μm | 32.5 μm | 35.0 μm |
| lubricating layer: thickness | | | |
| Compression-torsion test | A | B | C |
| evaluation | | | |

As shown in Table 1, the evaluation samples made from the gaskets in Examples 2-1 and 2-2 using the primer coating composition according to the present disclosure have a high primer layer remaining property even after the compression-torsion test. As can be seen from this, the primer layers included in the gaskets in Examples 2-1 and 2-2 have excellent adhesion to the substrate, have excellent abrasion resistance, and can prevent the damage to the substrate. In contrast, the evaluation sample made from the gasket in Comparative Example 2 using a primer coating composition different from that of the present disclosure, has a low remaining property after the compression-torsion test.

In addition, as shown in Figure, the evaluation samples made from the gaskets in Examples 2-1 and 2-2 using the primer coating composition according to the present disclosure require a large number of cycles before the friction coefficient starts to increase, while the evaluation sample made from the gasket in Comparative Example 2 using a primer coating composition different from that of the present disclosure requires a relatively small number of cycles before the friction coefficient starts to increase. The friction coefficient of the evaluation sample is maintained at a low value while the fine fluororesin particles remain between the substrate and the test jig, and starts to increase when these components disappear. Therefore, an evaluation sample that requires a large number of cycles before the friction coefficient starts to increase means that the evaluation sample has excellent adhesion to the substrate, has excellent abrasion resistance, and can prevent the damage to the substrate. Particularly, it can be seen that the evaluation sample made from the gasket in Example 2-2, which has a thick primer layer using the primer coating composition according to the present disclosure, has a very large number of cycles before the friction coefficient starts to increase.

### Industrial Applicability

The primer coating composition according to the present disclosure can give a primer layer having excellent adhesion to a substrate, having excellent abrasion resistance, and capable of preventing damage to the substrate, and can thus be suitably used, for example, to form a primer layer of a gasket.

What is claimed is:

1. A primer coating composition comprising:
an epoxy resin; and
fine fluororesin particles.

2. The primer coating composition according to claim 1, wherein the fine fluororesin particles are at least one kind selected from the group consisting of polytetrafluoroethylene (PTFE), a tetrafluoroethylene-perfluoroalkoxyethylene copolymer (PFA), a tetrafluoroethylene-hexafluoropropylene copolymer (FEP), a tetrafluoroethylene-ethylene copolymer (ETFE), polyvinylidene fluoride (PVDF), polychlorotrifluoroethylene (PCTFE), and an ethylene-chlorotrifluoroethylene copolymer (ECTFE).

3. The primer coating composition according to claim 1, wherein the fine fluororesin particles are contained in an amount of 5 to 50 parts by mass with respect to 100 parts by mass of the epoxy resin.

4. The primer coating composition according to claim 1, wherein the fine fluororesin particles have an average particle diameter of 3 μm to 18 μm.

5. Use of the primer coating composition according to claim 1 for coating a surface of a metal material.

6. Use of the primer coating composition according to claim 1 for coating a surface of a metal material of a gasket.

7. A primer layer, which is obtained by curing the primer coating composition according to claim 1.

8. A gasket comprising:
the primer layer according to the claim 7 directly formed on at least a portion thereof.
